(19) United States
(12) Patent Application Publication
(10) Pub. No.: US 2003/0151590 A1
(43) Pub. Date: Aug. 14, 2003

(54) Advertising system and method

(76) Inventor: Andrew William Pollard, Broadbeach Waters (AU)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/257,610

(22) PCT Filed: May 18, 2001
(86) PCT No.: PCT/AU01/00572

(30) Foreign Application Priority Data
May 19, 2000 (AU) PQ 7628

(51) Int. Cl. G09G 5/00

(52) U.S. Cl. 345/156

(57) ABSTRACT

An interactive display system (10) for providing information including a data storage, a display (12) and at least one selector (18), wherein the display (2) sequentially displays summary information from said data storage, and wherein the at least one selector (18) is capable of causing the display (12)to display further information relating to selected summary information; wherein said further information is obtained from said data storage.

### FIELD OF INVENTION

This invention relates to the provision of information, such as advertising material. In particular this invention relates to a system for providing information and to a method of providing information, including an advertising system and to a method of advertising.

### BACKGROUND

From billboards through to bus stands, a variety of media have been used to provide information, such as advertisements. Digital billboards scrolling through a number of advertisements have been used. These advertisements are presented in a predetermined sequence and in a manner which is independent of the viewer, who is unable to select from the sequence or control its progress. As there is no viewer interaction these types of advertising can be easily ignored.

There are also a number of on-line advertising systems, which impose on the user whilst they are attempting to obtain other services, such as information from the Internet or on-line databases. For example, advertisements may be displayed on a workstation when it is not being utilised by the user for other purposes or during intervals when a patron is waiting for some service to be provided at a workstation or terminal. These systems are also independent of the viewer and suffer from the absence of any interaction with the viewer other then passively viewing the advertisement.

We have found that providing information from a display with which the viewer actively interacts results in the viewer taking more interest in the information provided and therefore renders the provision of information more effectively. We have found a system whereby the viewer may actively interact with the displayed information and obtain further information in relation to the displayed information.

### BRIEF DESCRIPTION OF INVENTION

In one aspect, this invention resides in an interactive display system for providing advertising or promotional information, the display system including:

a self-contained computer having:

a data storage storing data relating to summary information and further information,

a display for displaying information,

at least one selector,

control logic for controlling the flow of data from the data storage to the display; wherein the control logic causes the display to sequentially display summary information obtained from said data storage, and the control logic causes, in response to activation of the at least one selector, the display to display further information relating to selected summary information; wherein said further information is obtained from said data storage, and

a communication means that enables the updating of the stored data at desired times.

The interactive system may be readily transported and, in a preferred embodiment, may be mobile, so that the system can opportunely be employed in environments that traditionally are not utilized to provide information and advertising.

The display may be any suitable display, such as screen using a cathode ray tube (CRT), liquid crystal display (LCD), light-emitting diode or any other image projection technology.

The at least one selector may include a switch, key, button, sound-activated switch, touch-sensitive pad, touch-sensitive screen or the like to enable a viewer to select desired summary information about which to obtain further information. The further information may be viewed on the display, printed or a combination thereof. In a preferred embodiment, the system includes a printer for provision of printed further information.

The data for the summary information and further information may be stored on any suitable storage medium, such as a hard disk, CD-ROM, floppy disks, other disks, tapes and the like. Suitably, the system incorporates a computerised hard disk drive including software and data that may be needed to control and manage the hardware and data flow of the summary and further information to the display and/or printer. The content of the summary information and the further information may be changed, updated and varied from time to time. For example, the content of the data storage may be updated by any suitable communication means such as by diskette, CD, infrared, Ethernet connection, General Packet Radio Service (GPRS), wireless LAN, or any other wireless systems.

The system may capture statistics, such as the number of occurrences of a viewer selecting to obtain desired further information and to which summary information the selection relates. Such statistics may enable the summary information to be optimised for effectiveness. Where the summary information is advertising material, the statistical information returned from the system provides a valuable measure of the effectiveness of the system. The captured statistics may include hits per summary information (the number of occurrences that further information is requested in relation to any particular summary information), number of printed documents, number of language requests, etc. For example, the statistics may be captured by a software program stored on the hard disk. Statistical information may be uploaded to other systems for analysis by any convenient means, such as manual transfer to a storage medium or remote transfer, such as via infrared or satellite.

The summary information and further information may include any multimedia, such as text, graphics, video, animation, sound or any combination thereof. The further information may additionally include printed matter. In an advertising application, the summary information may include an advertising message, such as a graphical image or short video advertisement for a business and the further information may include graphical images, video or sound augmenting the summary information, contact details, product and price lists, vouchers, coupons, or any other promotional material. Obviously, the subject matter of the summary information and further information is endless and dependent on location. Further, the programmed arrangement of summary information and further information is variable, and dependent on the needs of the information provider.

Suitably, the display continuously displays the summary information from the data storage in sequence. If a viewer is interested in the summary information they can press the at least one selector, which is capable of interrupting the continuous display and causes the display to display further information relating to selected summary information. After the further information has been displayed the display reverts to continuously displaying the summary information.

In one embodiment, the summary information is a graphical image advertisement of a business and the further information includes a short promotional video and/or a printed docket. The docket may include the contact details of advertised business and/or a promotional offer. For example, the system may display a screen show of still image advertisements. If a viewer requires more information about an advertised business, they press the “further information” button and a multimedia video about the selected advertised is displayed. Alternatively, if the viewer presses the “further information” button, a docket may be printed. In as still further embodiment, if the viewer presses the “further information” button, a docket may be printed at the same time as the multimedia video is displayed.

The interactive display system of this invention may be employed in any suitable environment, such as in hotels, shopping centers and malls, train stations, bus depots, buildings, airports etc. In a preferred embodiment, the interactive display system of invention may be used in transportation applications, particularly public transport vehicles, such as buses, trains, ferries and taxicabs. Traditionally public transport vehicles employ static advertising such as posters and signs placed internally and externally of the vehicle. Advertising systems which scroll through a series or sequence of advertisements have also been employed in transportation applications. However, such applications are passive in that they do not enable active interaction with the individual viewers.

Accordingly, in a preferred embodiment of this invention there is provided an advertising display system for use in transportation including an interactive display system as described above. For example, the interactive display system may be mounted in a vehicle, such as a taxicab.

In another aspect this invention resides in an interactive display system for providing information including a data storage, a display and at least one selector, wherein the display continuously displays summary information from said data storage sequentially, and wherein the at least one selector is capable of interrupting the continuous display and causing the display to display further information relating to selected summary information.

After the further information has been displayed the display may revert to continuously displaying the summary information.

In a further aspect, this invention resides in method of providing information in an interactive display system, including the steps of:

displaying a sequence of summary information to a viewer, and

providing at least one selector whereby said viewer selects summary information and further information relating to the selected summary information is provided, wherein the summary information and further information are stored in the interactive system.

In a still further aspect, this invention resides in an interactive display system mounted in a vehicle for providing information including a data storage, a display and at least one selector, wherein the display sequentially displays summary multimedia information from said data storage, and wherein the at least one selector is capable of causing the display to display further multimedia information relating to selected summary information, wherein said further information is obtained from said data storage.

In a still further aspect, this invention resides in an interactive display system for providing information including a data storage, a display, a printer and at least one selector, wherein the display sequentially displays summary information from said data storage, and wherein the at least one selector is capable of causing the printer to print further information relating to selected summary information, wherein said further information is obtained from said data storage.

### BRIEF DESCRIPTION OF DRAWINGS

In order that this invention may be more readily understood and put into practical effect, reference will now be made to the accompanying drawings which illustrate a preferred embodiment of the invention and wherein:

FIG. 1 depicts an interactive advertising system mounted in a vehicle;

FIG. 2 is a front view of the display screen of an interactive advertising system displaying an advertisement;

FIG. 3 is a side view of the display screen illustrated in FIG. 2;

FIG. 4 is the A-A cross-sectional view of the display screen illustrated in FIG. 2;

FIG. 5 is a bottom view of the display screen illustrated in FIG. 2;

FIG. 6 is a perspective view of the components of the display screen illustrated in FIG. 2;

FIG. 7 is perspective view of the printer of the interactive advertising system of this invention;

FIG. 8 is a front view of the printer illustrated in FIG. 6;

FIG. 9 is the A-A cross-sectional view of the printer illustrated in FIG. 6, and

10 is an example of printed matter from the interactive advertising system of this invention.

### DETAILED DESCRIPTION OF PREFERRED EMBODIMENTS

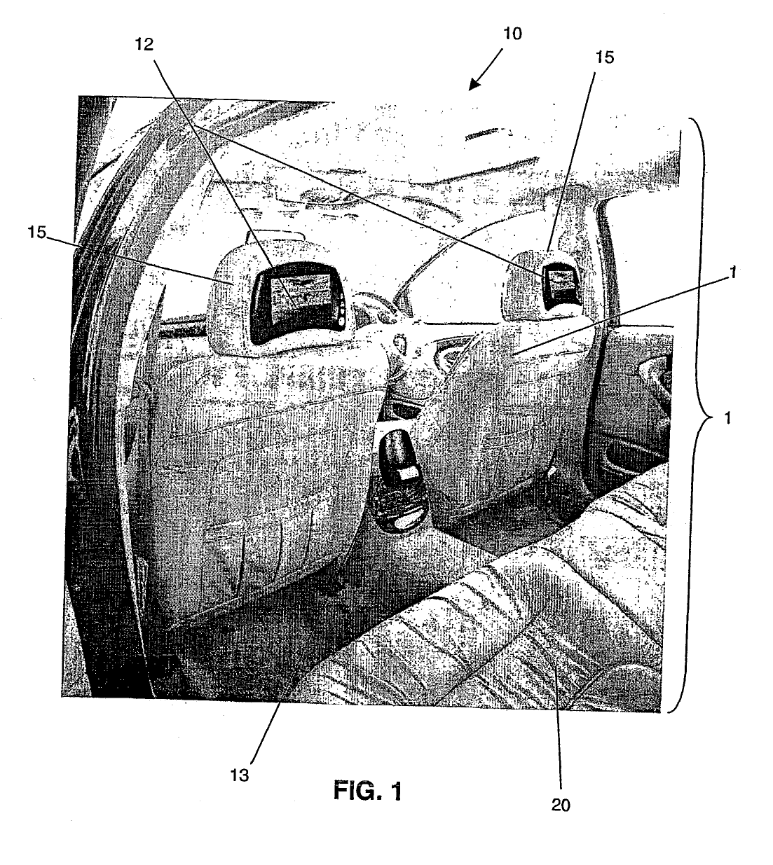

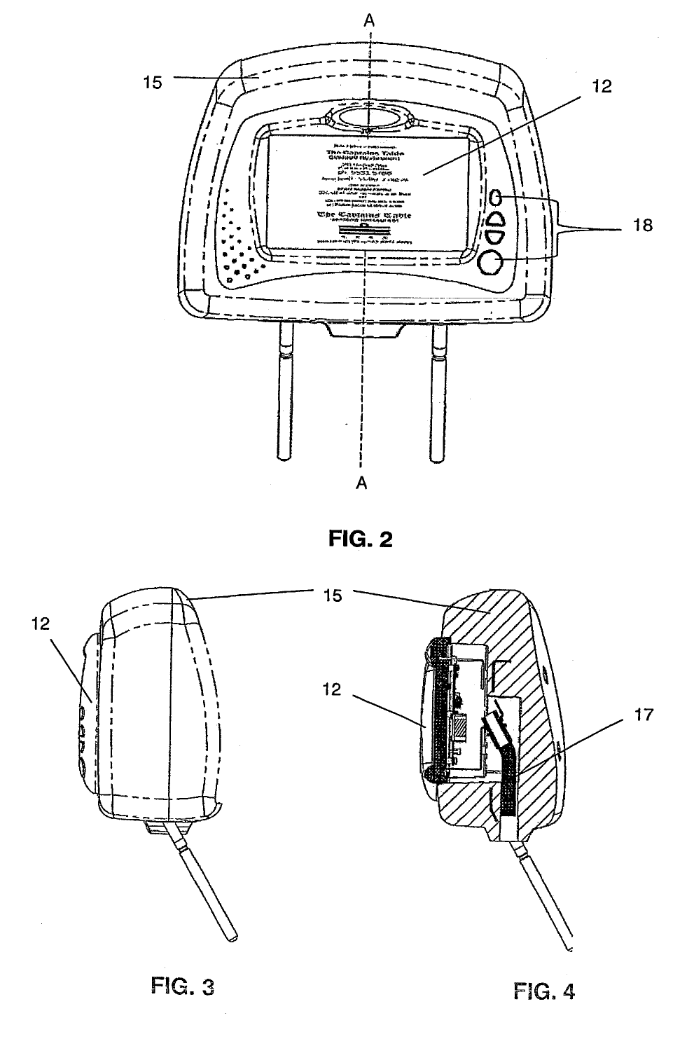

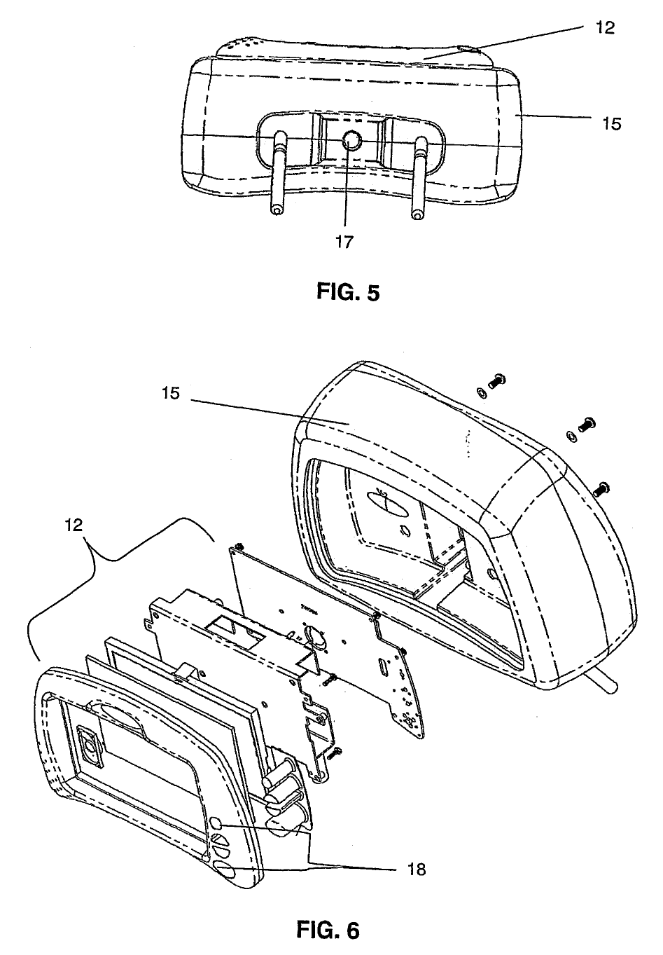

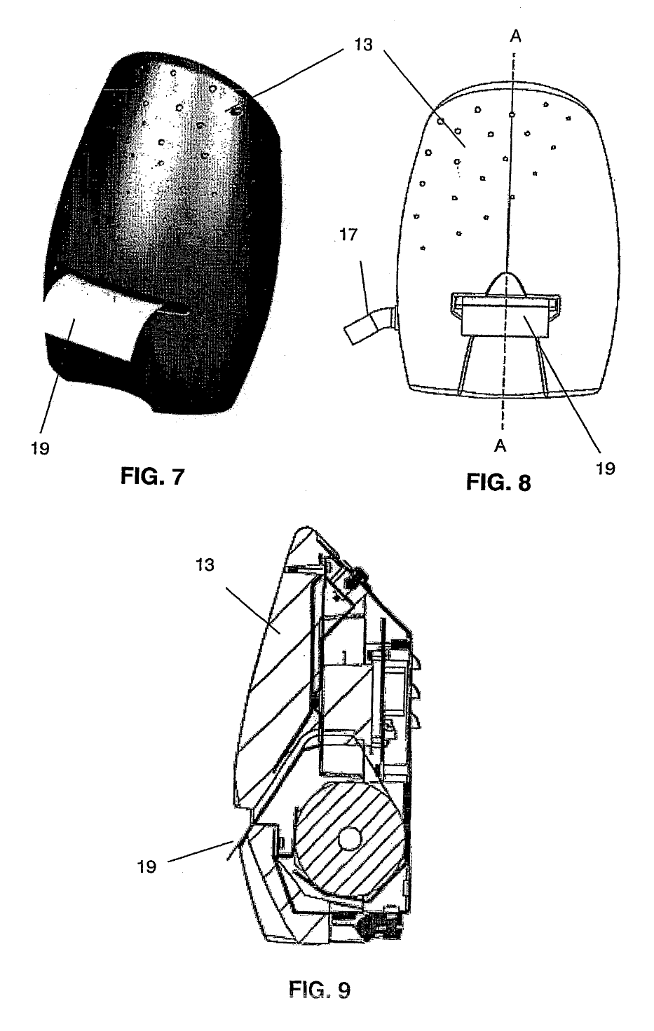

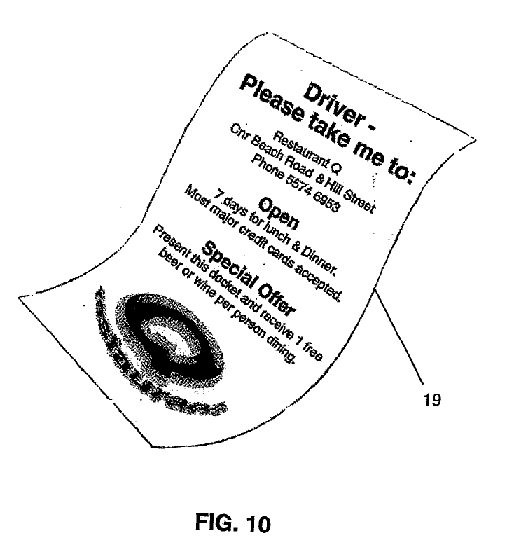

Referring to FIGS. 1 to 9, there is illustrated an interactive advertising system 10 mounted in a vehicle 11, such as a taxicab. The interactive advertising system 10 comprises a computer including a display screen 12, a printer 13, a storage-medium 14 (not shown)and a central processing unit (CPU) (not shown). It is to be understood that in all components of the interactive advertising system 10 can be self-contained. For example, the display screen 12, printer 13, storage-medium 14 and CPU could be enclosed within the same housing. Alternatively as illustrated in the drawings, the various components of the advertising system 10 are interconnected but self contained in that it is an independent system that does not rely on any external data source or device.

Referring to FIGS. 1 to 6, the display screen 12 is fitted into a custom designed headrest 15 of the front seat 15 of the vehicle 11. Suitably, display screens 12 are installed in both the driver and passenger seat. One or more selectors or buttons 18 are located on the display screen 12 to enable a viewer to select the various functions of the interactive advertising system 10. In one embodiment, the passenger and driver screens 12 display the same image, however only one of the screens 12 may include navigation buttons 18. The screen 12 without navigation buttons 18 may simply be a slave screen 12.

A device housing the CPU also contains the data storage and associated logic to control the flow of information from the data storage and administer the system, is mounted under the passenger's seat and wired to the vehicle's power supply. The printer 13 is a preferably a thermal printer and can be mounted in various positions in the vehicle. In FIG. 1, the printer 13 is mounted on the centre console for ease of accessibility to the passengers in the back seat 20 of the vehicle 11. The display screen 12 and the printer 13 are linked to the data storage and CPU via an armoured cable 17 threaded through the seat cavity.

When there is no viewer interaction, a sequence of summary information, such as advertising messages, is displayed continuously on the screen 12. For example, the summary information may be a screen show of advertisements or scroll images displayed in sequence. Suitably, the scroll image is a still image that is displayed for a brief period of time, say 3 seconds.

The buttons 18 enable a viewer to interact with the interactive advertising system 10 to obtain further information relating to a desired summary information, i.e. an advertising message of interest to the viewer. When a viewer is attracted to a particular advertising message, they may press the “more information” button 18, which displays further information, such as a multimedia file. For example, the multimedia file may be a short video such as TV like commercial for the advertised business relating to selected scroll image. The multimedia file can also include sound, such as an imbedded MPEG.

The viewer may also press a “print” button 18, which prints a docket relating to the relevant scroll image, such as illustrated in FIG. 10. The docket 19 may included the advertiser's contact details and/or a promotional offer, such as a free bottle of wine with dinner or 10% off a ticket price. In a preferred embodiment, the “more information” button 18 will print the docket at the same time as displaying the multimedia video file.

Multiple language formats are available and the user can press a desired language button 18. When pressed, a viewer can toggle though a number of different languages that may be available. In addition, there may be a button for selectively displaying a desired summary information. For example, there may be a skip button to enable a viewer to scroll backwards and forwards between the advertising messages. If the viewer does not press any of the available buttons 18, the next still image in the summary information screen show is displayed.

The summary information and further information can include any multimedia format including text, graphics, video, animation, sound or any combination thereof. The amount and type of information provided by the interactive advertising system 10 is potentially unlimited, and can be updated and changed periodically. In one embodiment, the interactive advertising system 10 has an infrared device that enables information to be downloaded in a matter of seconds from up to three metres away. Alternatively, the advertising data content on the storage-medium 14 may be updated by an Ethernet connection, GPRS, wireless LAN or other suitable wireless technologies.

The interactive adverting system 10 is able capture statistics to which summary information can be provided to the advertiser to measure the effectiveness of their advertising. For example, the statistics may include the number hours per day the system is in operation, the number of times a language is selected, statistics on total number of site impressions, site hits and the number of dockets printed from each site. Statistical information can be uploaded via an infrared device or other like wireless device to a central location for analysis.

An advertiser, utilising the preferred embodiment of the invention, may in fact have three advertising opportunities, being:

an advertising space for their scroll image,

an advertising space for their interactive multimedia content, and

an advertising space for the docket printer image.

In one embodiment, the first space is the scroll image. This image will be displayed in a sequence of advertising message. This image may be any suitable file format, such as bit map, JPEG, Tiff, GIF, or the like. Compressed file formats may be preferred if memory is a concern.

The second space is the “interactive level” space. A viewer will access this level via the “more information” button 18 when viewing the scroll images. This space is used to store the multimedia content the advertiser wishes to show, such as a short video.

The third space is the docket image. The printer 13 will print the docket image when a passenger presses the “print” button from the “interactive level”. Alternatively, the “more information” button may print the docket image at the same time as the multimedia video content. Suitably, the image includes contact details of the advertiser, as well as the offer they wish to promote. Similar to the first level, the image may be any suitable file format, such as bit map, JPEG, Tiff, GIF, or the like.

In the preferred embodiment, the interactive advertising system 10 is located in taxicabs 11 as seen in FIG. 1. A passenger or viewer is able to access the system 10 by interacting with the buttons 18 from the back seat 20 of the taxicab 11. Suitably, the interactive advertising system 10 is designed to boot-up when the vehicle is started, shutdown when the vehicle is stopped and operate continuously when a vehicle is running, so that interference is not required by the driver of the vehicle.

The use of the interactive advertising system 10 inside taxicabs allows advertisers to promote their business to passengers in a new environment. In such an environment, the interactive advertising system 10 entices passenger interaction and the advertising is provided with valuable marketing feedback and learnings.

It will of course be realised that while the foregoing has been given by way of illustrative example of this invention, all such and other modifications and variations thereto as would be apparent to persons skilled in the art are deemed to fall within the broad scope and ambit of this invention as is herein set forth.

The claims defining the invention are as follows:

1. An interactive display system for providing advertising or promotional information, the display system including:
a self-contained computer having:
a data storage storing data relating to summary information and further information,
a display for displaying information,
at least one selector,
control logic for controlling the flow of data from the data storage to the display; wherein the control logic causes the display to sequentially display summary information obtained from said data storage, and the control logic causes, in response to activation of at least one selector, the display to display further information relating to selected summary information; wherein said further information is obtained from said data storage, and
communication means that enables the updating of the stored data at desired times.

2. An interactive system according to claim 1, wherein the system is mobile.

3. An interactive system according to claim 1 or claim 2, wherein the data storage is a computer hard disk.

4. An interactive system according to any one of claims 1 to 3, wherein the summary information and further information is advertising material.

5. An interactive system according to any one of claims 1 to 4, wherein the summary information and further information is multimedia.

6. An interactive system according to any one of claims 1 to 5, wherein the sequential display of summary information is displayed as a screen show of still images.

7. An interactive system according to any one of claims 1 to 6, wherein the system includes a printer.

8. An interactive system according to claim 7, wherein the printer prints further information relating to selected summary information in response to activation of at least one selector.

9. An interactive system according to any one of claims 1 to 8, wherein further information is displayed as a video in response to activation of at least one selector.

10. An interactive system according to any one of claims 1 to 9, wherein the system includes a selector to choose the language of the summary and further information.

11. An interactive system according to any one of claims 1 to 10, wherein the system includes a selector to scroll backwards or forwards between the sequence of summary information.

12. An interactive system according to any of claims 1 to 11, wherein the system captures statistics relating to the summary and further information.

13. An interactive system according to any one of claims 1 to 12, wherein the communication means includes an Ethernet connection.

14. An interactive system according to any one of claims 1 to 12, wherein the communication means includes a wireless connection.

15. An interactive system according to either of claims 12 or 13, wherein the communication means includes an Ethernet connection and a wireless connection.

16. An interactive system according to any one of claims 1 to 15, wherein the system is installed in a vehicle.

17. An interactive system according to claim 16, wherein the vehicle is a taxicab.

18. An interactive system according to claim 5, wherein the multimedia is selected from text, graphics, video, animation, sound or a combination thereof.

19. An interactive display system according to any one of claims 1 to 18, wherein the display continuously displays the sequence of summary information until activation of the at least one selector interrupts the continuous display to display further information relating to the selected summary information.

20. An interactive display system according to claim 196, wherein after completion of the display of the further information the display reverts to continuously displaying the sequence of summary information.

21. A method of providing advertising or promotional information in an interactive display system according to any one of claims 1 to 20, including the steps of:
continuously displaying a sequence of the summary information,
interrupting the continuous display to display further information relating to summary information selected in response to activation of at least one selector, and
reverting to continuous display upon completion of the display of further information.
